(19) United States
(12) Patent Application Publication
(10) Pub. No.: US 2013/0307702 A1
(43) Pub. Date: Nov. 21, 2013

(54) METHOD AND SYSTEM FOR EFFECTIVE MANAGEMENT OF ENERGY CONSUMPTION BY HOUSEHOLD APPLIANCES

(71) Applicants: Arpan Pal, Kolkata (IN); Subrata Kolay, Kolkata (IN); Chirabrata Bhaumik, Kolkata (IN); Jasma Shukla, Kolkata (IN)

(72) Inventors: Arpan Pal, Kolkata (IN); Subrata Kolay, Kolkata (IN); Chirabrata Bhaumik, Kolkata (IN); Jasma Shukla, Kolkata (IN)

(73) Assignee: TATA CONSULTANCY SERVICES LIMITED, Mumbai (IN)

(21) Appl. No.: 13/979,619

(22) PCT Filed: Jan. 13, 2012
(86) PCT No.: PCT/IN2012/000036

§ 371 Date: Aug. 8, 2013

(30) Foreign Application Priority Data
Jan. 13, 2011 (IN) 118/MUM/2011

(51) Int. Cl. G01D 4/00

(52) U.S. Cl. CPC G01D 4/002
USPC 340/870.02

(57) ABSTRACT

A method and system for effective management of energy consumption by household appliances, using a home energy information gateway. Particularly, the invention provides a method and system for an efficient and economic home energy information gateway which can provide the energy consumption information and communication interface through a set top box like gateway device on the existing display device such as television thereby reducing extra display medium cost. More particularly, the invention provides a method and system for managing energy consumption effectively by monitoring, controlling and displaying energy usage of household appliances by way of collecting smart meter data and generating user friendly reports and graphs.

### FIELD OF THE INVENTION

The present invention relates to effective management of energy consumption. Particularly the invention provides a method and system for effective management of energy consumption by household appliances using a home energy information gateway.

### BACKGROUND OF THE INVENTION

With the advent of the internet of things, real-time communications will be possible not only by humans but also by things at anytime and from anywhere. It would create a plethora of innovative applications and services, which, in turn would enhance the quality of life and reduce inequalities whilst providing new revenue opportunities for a host of enterprising businesses. In order to connect everyday objects and devices to large databases and networks, and indeed to the network of networks (the internet), a simple, unobtrusive and cost-effective system of item identification is crucial only then can data about things be collected and processed.

Rising energy costs and more frequent disruptions in electric service have caused consumers to focus more attention on their energy usage and bills. A user is in better situation to control energy more effectively when they have more information on ‘where when what’ amount of energy is consumed. More the detailed information is available more the control on energy consumption is possible. From energy provider's point of view also the information is useful, for example, with detailed data collected through the home energy information gateway, an energy provider will be able to predict more accurately when supply and demand imbalances may occur. The provider could then use the energy gateway to remotely adjust the customer's thermostat, if so equipped, within agreed-upon parameters, to achieve necessary load reduction targets.

Although, information about the energy consumption for home is made available to the user in various forms and by various methods, still there are certain disadvantages associated with the existing energy information gateway. A dedicated display device is always required to view and control the energy information, such as personal computer. The computer is having Java, graphical user interface (GUI)—operating system (OS) and the latest Internet technologies. User needs to open an account which will be configured in the smart meter, which monitors the energy consumption. The smart meter transmits energy consumption data to the remote server at periodic intervals and the user needs to login into his/her account using a personal computer based browser. The user has to log in to their personal computers in order to keep track of the energy consumption patterns and has to generate and visualize weekly, monthly or yearly energy consumption data on the display device. Most of the existing solutions tend to use personal computer or other high-cost devices for processing and viewing energy data. Which is not convenient for non-tech savvy people and it also consumes high energy if kept on all the time. Hence if the display device itself consumes high power, it self-defeats the purpose of energy conservation. A dedicated display device would not be preferable from economic and energy consumption point of view.

In the existing solution, some of the major drawbacks which are being faced: some of them utilizes separate touch panel based display medium for monitoring and controlling of the household appliances, which increase the overall cost, lack of 24×7 monitoring and controlling of household appliances using television, control solution that require human intervention, non consideration of local whether or environmental conditions affecting household appliances, scheduling overall consumption by setting up budget for the month and the basic level data analytics of the energy consumption. In addition, if the users are enabled to view current tariff, current consumption and costing for each of the high consumed appliances on real time then user can more effectively control each of the appliances either by shifting the load or turning off the load when it is not necessary and thereby reduce the total energy consumption inside home and reduce the overall peak energy demand.

To achieve the effective management of energy consumption by household appliances, there is a need to device a solution which can act as a home energy information gateway. There is also need for a solution which can utilize the existing display device and home area network for eliminating the need of a dedicated display device. Some of the existing method and systems known to us are as follows:

US2010321574A to Kerofsky provides a method and systems for controlling power consumption with a power controlling display device. Kerofsky teaches the about a power controlling display device that receives power cost data and user preferences and generates a power consumption schedule that may control internal display components as well as connected power consuming devices.

US2010127889A to Vogel et al. provides a method and system of virtual energy management display. Vogel, et al. specifically teaches about the periodically receiving via a mesh local area network electronic data representing energy management-related information by a RF communication-enabled memory storage device coupled to an electronic display device within a home area network.

EP2157408A to Egmond et al. provides a low-cost display device. Egmond et al. Yedida, et al.

specifically teaches about rendering actual information on the energy consumption at home, enabling the consumer to set a target to save energy consumption, and to see the outcome whether the target is fulfilled or not.

Beecher Tuttle in “Smart home|Toyota to Roll Out home Energy Management System in 2012” discloses an effort to enable its customer base to better control its energy consumption, Toyota recently announced that it is developing a smart center system that links households, vehicles and electric power companies. The all-in-one energy management system will allow customers to use their television or mobile phone to monitor the amount of energy that is consumed by their home.

Jim Hammett in “Interactive home Energy Management” discloses about a pilot program, in which 50 homes will use Edison's existing fiber optic network in combination with local telephone and cable television facilities. AEMS provides an energy profile for each of appliances and compares energy use at any instant, or on a daily, weekly, or monthly basis. Home owners can compare different rates offered by Edison, and participants will receive a customized bill showing how each monitored appliance contributes to the total bill.

Kushiro, N. et al. in “Integrated residential gateway controller for home energy management system” discloses a low cost and highly reliable residential gateway controller (residential G/W) with plug & play mechanism has been developed for home energy management system (HEMS).

Inoue, M. et al. in “Network architecture for home energy management system” discloses network architecture for home energy management system (HEMS).

The above mentioned prior arts fail to disclose an efficient method and system for effective management of energy consumption by household appliances. Prior art also fails to disclose method and system that can utilize the existing display device and home area network for delivering energy usage information of household appliances into the hands of consumers.

Thus, in the light of the above mentioned background art, it is evident that, there is a need for a solution that can effectively manage energy consumption by household appliances and eliminating the need for a separate display device and home area network for delivering energy usage information of household appliances.

### OBJECTIVES OF THE INVENTION

In accordance with the present invention, the primary objective is to provide a method and system for effective management of energy consumption by household appliances using a home energy information gateway.

Another objective of the invention is to provide a method and system for an efficient and economic home energy information gateway which can provide the energy consumption information and communication interface through a set top box like gateway device on the existing display device such as television thereby reducing extra display medium cost.

Another objective of the invention is to enable a user to monitor energy consumption of household appliances, regulating energy consumption of the said household appliances and overriding curtailment initiatives using a web user interface for optimizing the said energy consumption of household appliances.

Another objective of the invention is to provide a method and system for generating daily, weekly, peek hour, customized energy consumption detailed statistical reports and graphs including the energy consumption price at that time based on the current tariff using an energy viewer application on the said television to control and effectively manage energy consumption.

Another objective of the invention is to enable an energy provider to predict supply and demand imbalances and accordingly plan for tuning the energy grid using detailed data being collected through the said home energy information gateway.

Yet another objective of the invention is to enable the user to view and manage home energy consumption by the said household appliances using the internet support of wired (Ethernet) or wireless (3G) internet connection

Still another objective of the invention is to provide a method and system for fetching local weather condition from weather website, intelligent rule engine setting some of the appliance in such weather condition so that it consumes less energy.

### SUMMARY OF THE INVENTION

Before the present methods, systems, and hardware enablement are described, it is to be understood that this invention in not limited to the particular systems, and methodologies described, as there can be multiple possible embodiments of the present invention which are not expressly illustrated in the present disclosure. It is also to be understood that the terminology used in the description is for the purpose of describing the particular versions or embodiments only, and is not intended to limit the scope of the present invention.

The present invention provides effective management of energy consumption by household appliances using a household energy information gateway.

In an embodiment of the invention a method and system is provided for an economic and efficient energy information gateway which can provide the energy consumption information using smart meter and communication interface through a set top box like gateway device on the existing display device such as television connected over a home area network.

In an embodiment of the invention the method is provided for identifying energy consumption of household appliance at pre-defined interval and transmitting the identified energy consumption information to a set top box using an advanced energy smart meter; receiving the transmitted energy consumption information via a serial communications protocol, (Modbus 485), Zigbee or M-bus and communicating the received energy consumption information to a remote server for further billing of the said energy consumption at pre-scheduled intervals by the said set top box; validating the received, communicated and billed energy consumption information by the set top box; and analyzing the validated energy consumption information for further display on a television and optimizing the energy consumption using displayed energy consumption information of the said household appliance for effective management of energy consumption.

In an embodiment of the invention the method and system is provided for generating daily, weekly, peek hour, customized energy consumption detailed statistical reports and graphs including the energy consumption price at that time based on the current tariff using an energy viewer application on the said television to control and effectively manage energy consumption. The invention also offers a varied range of benefits to the consumers and energy utility as well as non-utility providers.

The above said method and system are preferably effective management of energy consumption by household appliances using home energy information gateway but also can be used for many other applications.

### BRIEF DESCRIPTION OF THE DRAWINGS

The foregoing summary, as well as the following detailed description of preferred embodiments, are better understood when read in conjunction with the appended drawings. For the purpose of illustrating the invention, there is shown in the drawings exemplary constructions of the invention; however, the invention is not limited to the specific methods and system disclosed. In the drawings:

FIG. 1: shows a flow diagram of home energy information gateway

FIG. 2: shows block diagram of home energy information gateway

FIG. 3: representing daily energy consumption chart

FIG. 4: representing energy consumption web interface home page

FIG. 5: representing web interface showing appliance monitoring and control

FIG. 6: representing web interface showing weekly consumption chart

FIG. 7: shows a call flow diagram of home energy information gateway

### DETAILED DESCRIPTION OF THE INVENTION

Some embodiments of this invention, illustrating all its features, will now be discussed in detail.

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described.

The disclosed embodiments are merely exemplary of the invention, which may be embodied in various forms.

The present invention enables a method and system for effective management of energy consumption by monitoring, controlling and displaying energy usage inside home by way of collecting smart meter data and generating user friendly reports and graphs. More particularly the invention provides method and system for displaying the smart meter data and communication interface through a set top box like gateway on the existing display devices such as television in terms of widgets.

The present application provides a method for effective management of energy consumption by a plurality of appliances, characterized by employing a home energy information gateway over a dedicated local area network communicatively coupled with said plurality of appliance, the said method comprising computer implemented steps of:
a. identifying energy consumption of at least one appliance at pre-defined interval and transmitting the identified energy consumption information to a set top box (210) using an advanced energy smart meter (208);
b. communicating the identified energy consumption information to a remote server for further billing of the said energy consumption at pre-scheduled intervals by the said set top box (210); and
c. analyzing the validated energy consumption information for further display on a television (212) to optimize the energy consumption by controlling said appliances using displayed energy consumption information of the said appliance for effective management of energy consumption.

The present application provides a system for effective management of energy consumption by a plurality of appliances, characterized in employing a home energy information gateway over a dedicated home area network communicatively coupled with said plurality of appliance, wherein the system comprising:
a. a plurality of appliances communicatively coupled with the said home energy information gateway over a home area network (HAN);
b. an advanced energy smart meter (208) communicatively coupled with the said plurality of appliances and the said home energy information gateway over a home area network (HAN) adapted to identify energy consumption of the said plurality of appliance at pre-defined interval and further transmit the same;
c. a set top box (STB) (210) communicatively coupled with the said home area network (HAN) adapted to receive the transmitted energy consumption information by the said advanced energy smart meter (208) via a serial communications protocol, Zigbee, M Bus or power line, communicating the received energy consumption information to a remote server for further billing of the said energy consumption at pre-scheduled intervals and validate the received, communicated and billed energy consumption information;
d. an analytics rule engine running on the home energy information gateway adapted for supporting analytics of energy consumption data of the said plurality of appliances;
e. a television (212) adapted to display the validated energy consumption information and analysed energy consumption data of the said plurality of appliances for enhancing the end-user experience; and
f. a utility or non-utility web portal (216) hosted by a utility or non-utility server connected through Internet (214).

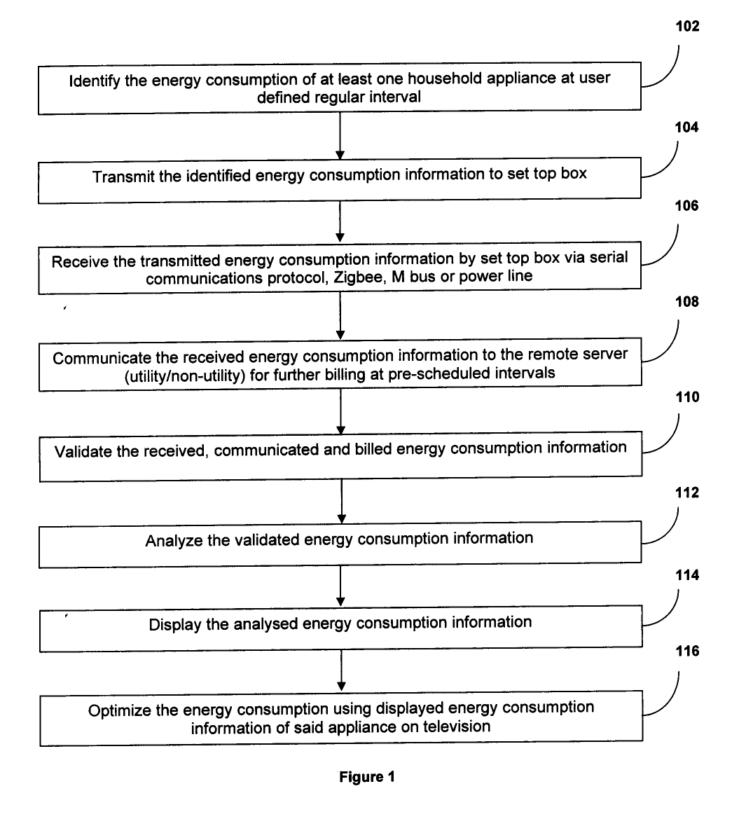

Referring to FIG. 1 is a flow diagram of home energy information gateway. The process starts at the step 102, the energy consumption of at least one household appliance at user defined regular interval is identified. At the step 104, the identified energy consumption information is transmitted to set top box. At the step 106, the transmitted energy consumption information is received by set top box via serial communications protocol, Zigbee, M bus or power line. At the step 108, the received energy consumption information is communicated to the remote server for further billing at pre-scheduled intervals. At the step 110, the received, communicated and billed energy consumption information is validated. At the step 112, the validated energy consumption information is analysed. At the step 114, the analysed energy consumption information is displayed. The process ends at the step 116, the energy consumption is optimized using displayed energy consumption information of at least household appliance through a set top box device on the television.

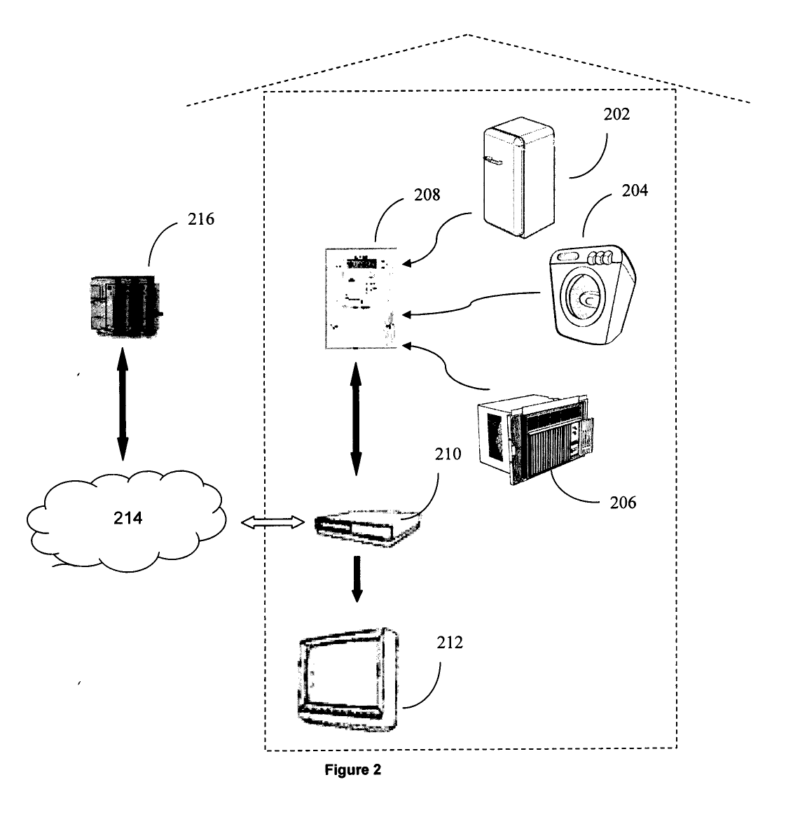

Referring to FIG. 2 is a block diagram of home energy information gateway. The home energy information gateway comprises a home area network (HAN) enabled refrigerator (202), a home area network (HAN) enabled washing machine (204), a home area network (HAN) enabled air conditioner (206) a home area network (HAN) enabled smart meter (208), a home area network (HAN) set top box (STB) (210), a television (212) and a utility/non-utility web portal (216) hosted by the utility/non-utility server connected through internet (214).

In one embodiment of the invention the energy consumption of household appliances is identified at regular interval using a smart meter (208) which is connected with household appliances. A smart meter (208) is an advanced energy meter that identifies consumption of individual households such as but not restricted to refrigerator (202), washing machine (204), air conditioner (206), television or microwave continuously at regular intervals than a conventional meter.

In an embodiment of the invention the smart meter (208) transmits the identified energy consumption information of the household appliance to set top box (STB) (210). The set top box (STB) (210) is used as the gateway among utility/ non-utility provider through a web portal (216) hosted by the utility/non-utility server, the smart energy meter (208) and household appliances. The set top box (STB) (210) is utilized as multiple connectivity options on the home area network (HAN) side. Further the set top box (STB) (210) receives the transmitted energy consumption information via a serial communications protocol. The serial communications protocol is selected from the group of RS485 mod-bus protocol, ZigBee and Power-line. The set top box (STB) (210) also comprises multiple universal serial bus (USB) ports and various connectivity options enabled in it using suitable universal serial bus (USB) dongles. It should be noted that, USB to Serial dongles is used for interfacing with Modbus 485 based smart meters (208). USB based Zigbee coordinator connected to the gateway which establishes the Zigbee PAN Network. Zigbee based Smart Meter (208) and Zigbee based smart appliances are connected to the Zigbee PAN network to form a mesh topology. In case of non-Zigbee based appliances, one Zigbee based plug can be placed in between said household appliances and power connection in this way non Zigbee based appliances can be connected to the gateway home area network in a retrofit system.

In an embodiment of the invention the set top box (STB) (210) communicates the received energy consumption information to the utility web portal (216) hosted or managed by the utility provider or non utility provider server connected through internet (214) for further billing at pre-scheduled intervals. The data can then be made available to the energy provider where servers are managed and hosted by utility provider. In case of non-utility service provider data are available to the non-utility provider. The energy consumption information is communicated to utility web portal (216) using automatic meter reading (AMR) techniques for monitoring and billing purposes. AMR technologies include mobile and network technologies based on telephony platforms (wired and wireless), radio frequency (RF), or power line transmission. So, in addition to providing readings, the meter can also receive (and act on) instructions sent from the utility.

In an embodiment of the invention the set top box (STB) (210) validates the received, communicated and billed energy consumption information. Further it analyzes the validated energy consumption information. The end user can view the energy consumption on television (212) through low power and cost effective set top box (STB) (210).

In an embodiment of the invention the user have the liberty to optimize the energy consumption by monitoring energy consumption of said appliances, regulating energy consumption of the said appliances by budgeting for the said appliances, wherein the said appliances are budgeted on monthly basis or energy tariff, scheduling the said appliances in the lower tariff zone of energy and overriding curtailment initiatives using a web user interface for optimizing the said energy consumption. The user have the liberty to optimize the energy consumption using displayed energy consumption information of household appliances on television (212) through low power and cost effective set top box (STB) (210). The energy consumption data collected through the set top box (STB) (210) also enables an energy provider/non-utility service provider to engage its customers in new ways. Through a web interface, users will be able to monitor their energy consumption, make changes in their usage, or override curtailment initiatives. The web interface might be hosted and managed by either utility provider or non-utility service provider depending on whether home energy information gateway send data to the utility provider or non-utility service provider. Energy/non-utility service providers and consumers can also work together to cut energy consumption through incentives such as time-of-use rates or load reduction rates. The said web user interface provides with the user weather or utility based controlling of the said appliances. The home energy information gateway also provides advanced data analytics using home energy information gateway analytics rule engine running on the home energy information gateway and further displaying the same on the television (212) through web portal (216). The advanced data analytics not only enhances the end-user experience but also facilitate utility provider to configure energy consumption tariff and send it to the set top box (STB) (210) via Internet. The said home energy information gateway analytics rule engine analyses energy consumption data for each of the said appliances as well as energy overall consumption data. The user is enabled to view and manage home energy consumption by the said appliances using the internet (214) by facilitating secure communication, wherein the secure communication is having complete data privacy with the non-utility service provider. It may also be utilized to provide latest news and update on energy usage to end-user as a ticker messages and or as RSS feed or server sent events.

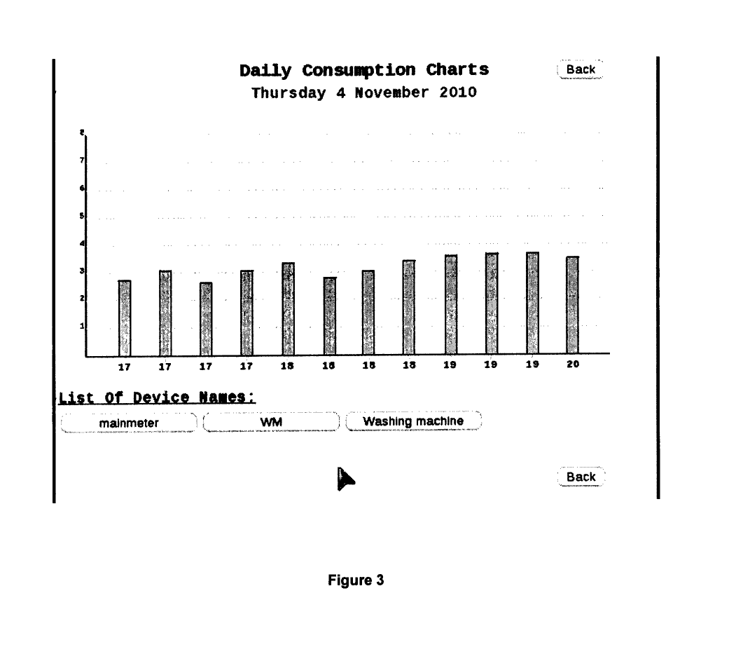

Referring to FIG. 3 is actual screenshot of the live data obtained from the smart meter (208). Wherein the user can obtain the weekly, daily as well as peek hour basis consumption of the energy. A user can generate daily consumption statistics and weekly consumption statistics. A detailed statistical analysis of the energy consumption day is possible, which when used in conjunction with dynamic tariff data, can intelligently suggest to the user the best possible power saving options and can declare incentive such time-of-use rates or load reduction rates which will be displayed on the television (212) screen. The current platform has an on-board digital signal processor (DSP) to support this kind of analytics computational load.

In an embodiment of the invention, the energy viewer application on television (212) is triggered by choosing the appropriate menu widget. The user can click on the “Daily Consumption” icon to get the energy consumption details throughout the day (Screen-shot shown in FIG. 3). Accordingly user can switch ON/OFF certain appliances to keep control on energy consumption. It also helps user to find if any appliances are running on sleep mode and consuming energy. A user can click on the “Weekly Consumption” icon to get the energy consumption details throughout the week user can get a statistical view which day of the week highest energy is consumed. The user can also view the energy consumption price at any time based on the current tariff. As shown in these figures, consumers can read the data and accordingly take action to reduce the energy consumption. Energy providers and consumer can also work together to cut energy consumption through incentive such as time-of-use rates or load reduction rates. Detailed data being collected through the home energy information gateway, an energy provider will able to predict more accurately when supply and demand imbalances may occur and accordingly plan for tuning the energy grid.

In an embodiment of the invention the home energy information gateway can talk to other smart appliances at home over the home area network (HAN). The users will be able to control the appliances from their television (212). Such appliances can also be controlled over the Internet, for an example a user switching ON home air conditioner from office. It will enable energy utility provider to securely remote control customer devices to reduce supply and demand imbalance. The home energy information gateway also facilitates the communication with the non-utility service provider which will enable user to view and manage home energy consumption over the Internet anytime anywhere. It also enables user to securely remote control appliances by switching on/off to cut-down energy consumption.

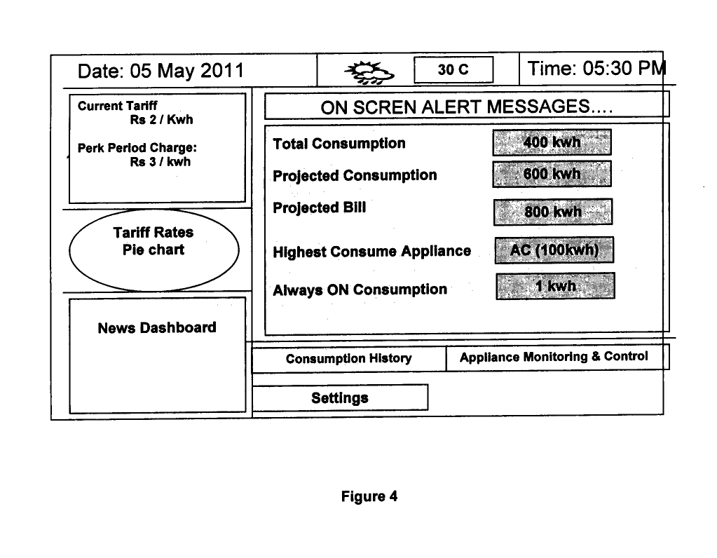

Referring to FIG. 4, 5, 6 are actual screenshot of the energy consumption web interface home page, web interface showing appliance monitoring and control and weekly consumption chart of the energy consumption of the said household appliances.

In an embodiment of the invention the user is enabled to read the energy consumption data obtained using the smart meter (208) and accordingly take necessary action to reduce the energy consumption. Energy providers and user can also work together to cut energy consumption through incentive such as time-of-use rates or load reduction rates. The tariff for energy consumption is sent to the home energy information gateway from the utility server. The current invention also envisages a scheme on energy consumption data analytics. A lot of statistical analysis is done on the collected energy consumption data, which when used in conjunction with dynamic tariff data, can intelligently suggest to the user the best possible power saving options and can declare incentive such time-of-use rates or load reduction rates for further display on the television (212).

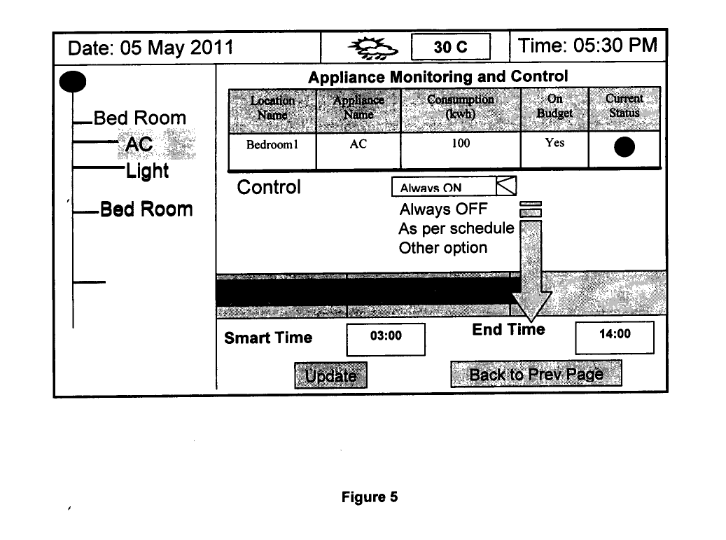

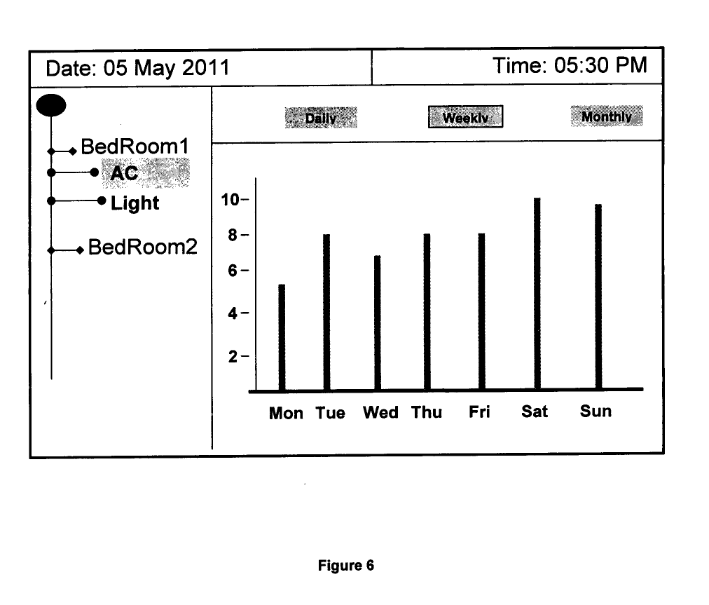

Referring to FIG. 3 to FIG. 6 are the screenshots of the wire diagram design for monitoring and controlling of the household appliances.

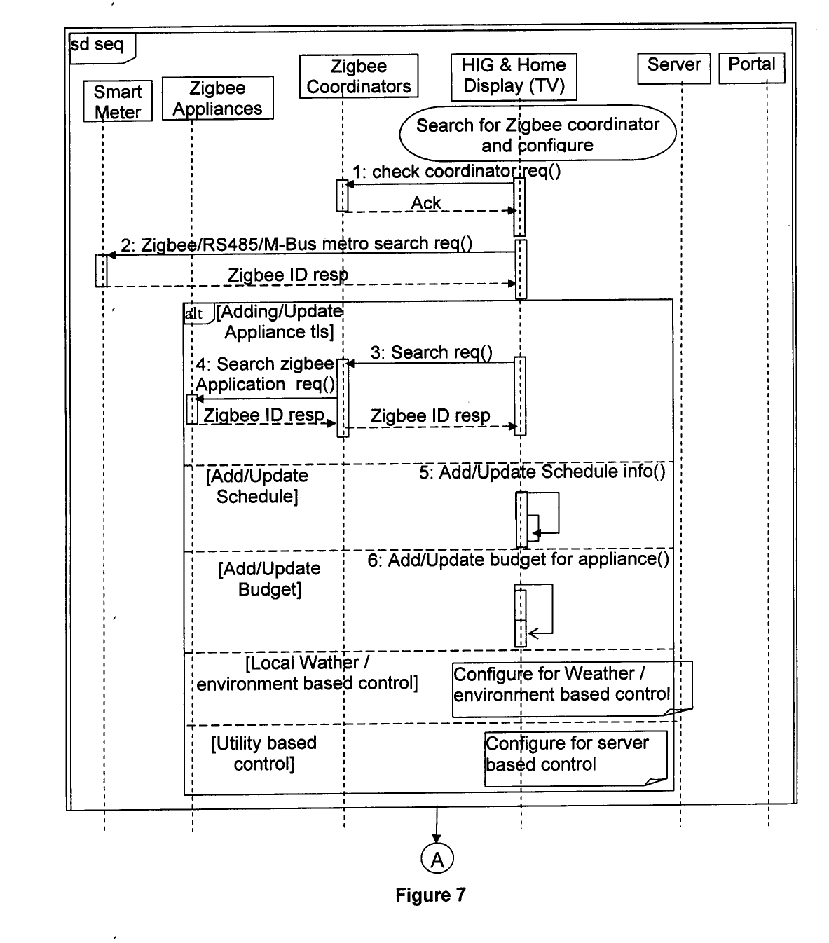

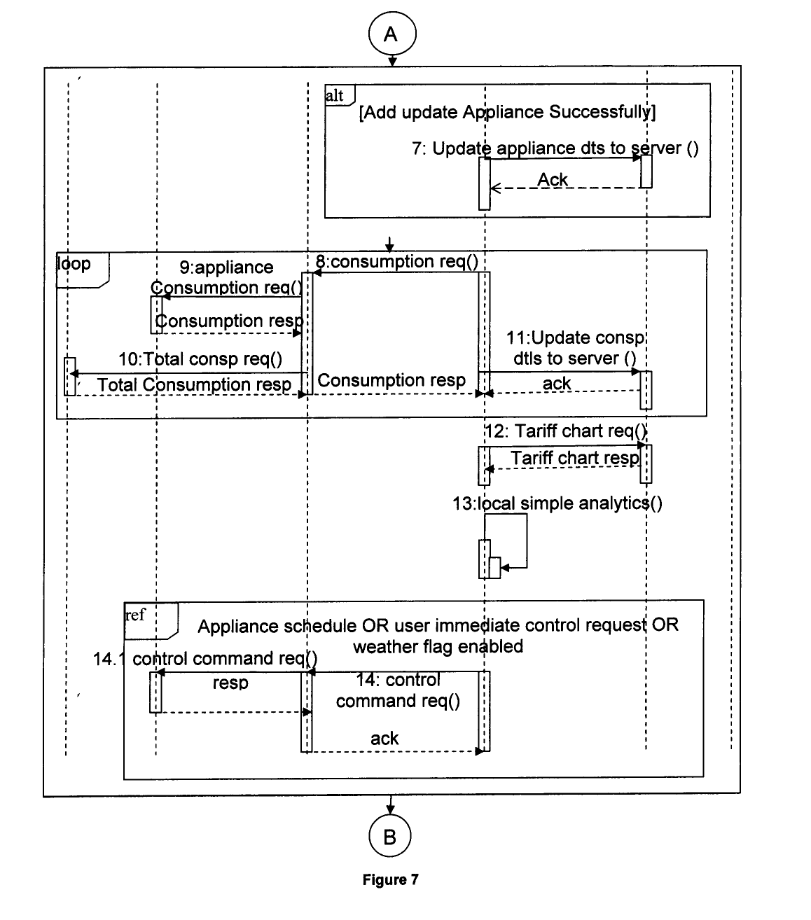

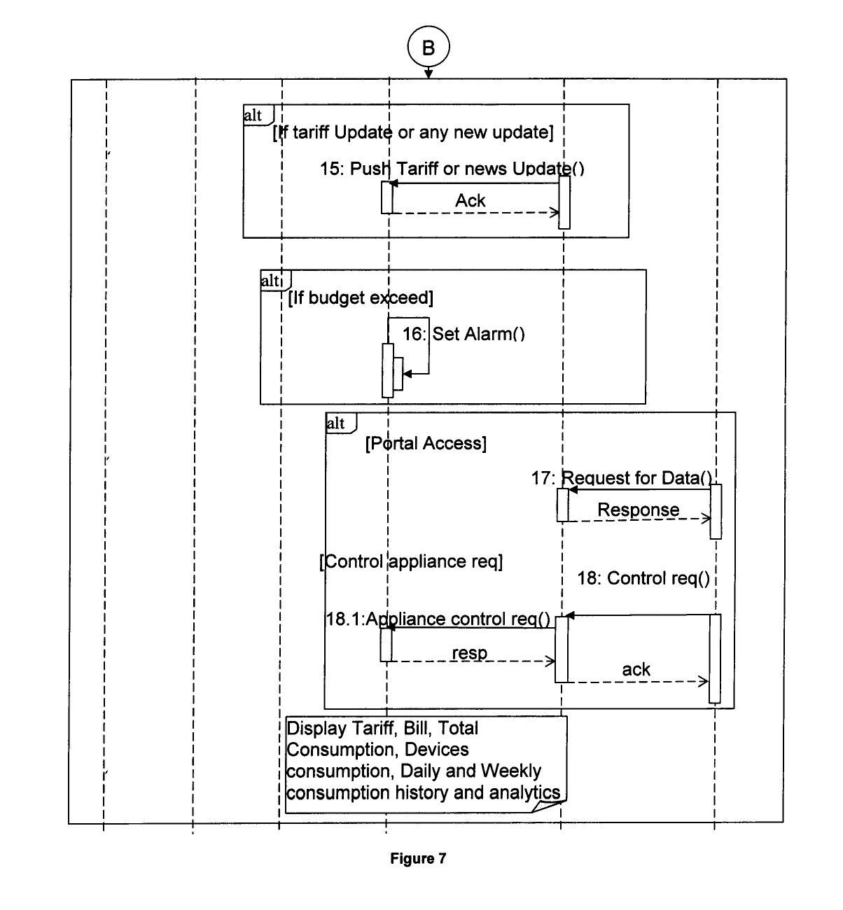

Referring to FIG. 7 is a call flow diagram of home energy information gateway.

In an embodiment of the invention the plurality of appliances communicates with the home energy information gateway using Zigbee communication protocol. In home display device, such as the television (212) is attached to the home energy information gateway. The advanced energy smart meter (208) is communicatively coupled with the home energy information gateway using Zigbee, M-Bus or Modbus protocol. The user has the liberty to monitor and control plurality of appliances from in home display such as television (212). First, the home energy information gateway start searching for a zigbee coordinator, upon finding the zigbee coordinator the home energy information gateway setup a zigbee network and channel and further conducts a basic coordinator test. The home energy information gateway then searches for the advanced energy smart meter (208) be it Zigbee/Modbus/M Bus based and get the advanced energy smart meter's (208) identification. The user is enabled to add new appliances or update the existing appliances using the web user interface. The home energy information gateway then search for all the communicatively coupled appliances and return Zigbee identification to the user. Upon receiving the Zigbee identification, the user may accept the zigbee identification for the said appliance. The user is given liberty to schedule the said appliance by providing the scheduling information for the said appliances. The user may also set the budget for the said appliances. The user also has the liberty to control the said appliances based on local weather and utility in future from the in home display such as the television (212). Further, the home energy information gateway fetches current energy consumption for each of the registered appliances at periodic interval and updates the remote server if connected. The home energy information gateway also fetches current energy consumption tariff for the first time and for the subsequent events the remote server pushes the tariff if there are any changes. The home energy information gateway also act intelligently to control appliances if time or budget scheduling is set for an appliances. The home energy information gateway also sets an alarm if energy consumption budget exceeds or in case of other news update from the remote server. The home energy information gateway is adapted to receive analytical result of the energy consumption data analysed by the remote server utilizing an analytics rule engine which is supporting analytics of energy consumption data of the said plurality of appliances. The home energy information gateway then displays the billing details, tariff details, energy consumption history of said plurality of appliances and analytics result of the energy consumption data on in home display such as the television (212). There is also a provision to control and monitor said plurality of appliances through a web portal.

The methodology and techniques described with respect to the exemplary embodiments can be performed using a machine or other computing device within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The machine may include a processor (e.g., a central processing unit (CPU), a graphics processing unit (GPU, or both), a main memory and a static memory, which communicate with each other via a bus. The machine may further include a video display unit (e.g., a liquid crystal displays (LCD), a flat panel, a solid state display, or a cathode ray tube (CRT)). The machine may include an input device (e.g., a keyboard) or touch-sensitive screen, a cursor control device (e.g., a mouse), a disk drive unit, a signal generation device (e.g., a speaker or remote control) and a network interface device.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

### ADVANTAGES OF THE INVENTION

The present invention provides more effective load management of energy; conservation and value added energy related services. The home energy information gateway delivers energy usage information into the hands of consumers and energy providers to help them control and manage energy consumption proactively.

The present invention enables consumers to read the data and accordingly take action to reduce the energy consumption. Energy utility/non-utility providers and consumer are also facilitated to work together to cut energy consumption through incentive such as time- of-use rates or load reduction rates.

The present invention provides with detailed data being collected through the gateway, enabling the energy provider to predict more accurately when supply and demand imbalances may occur and accordingly plan for tuning the energy grid.

The present invention provides interfacing with the household appliances allowing the user to control appliances centrally from their television and reducing energy consumption.

The present invention provides interfacing with local weather for helping user to minimize consumption proactively where user intervention is not required.

The present invention provides interfacing with the remote server allowing the user to run complex analytics on the remote server and send back result to the Gateway for displaying on television thus reducing the consumption and burden of having low horse powered Gateway.

The present invention enables the user to monitor and control household appliances over the Internet through a web portal (e.g. user switching-on home air conditioner from office), making it a true Internet-of-Things (IOT) use case.

The present invention enables the energy utility/non-utility provider to securely remote control customer devices to reduce supply and demand imbalance.

1. A method for effective management of energy consumption by a plurality of appliances, comprising:
identifying, at a set top box, energy consumption information of at least one appliance transmitted at pre-defined intervals by an advanced energy smart meter;
communicating, by the set top box, the identified energy consumption information to a remote server for validation, analysis, and billing of energy consumption at pre-scheduled intervals;
obtaining analysis results of the energy consumption information from the remote server for display on a television; and
optimizing energy consumption by controlling the at least one appliance using displayed energy consumption information of the at least one appliance.

2. The method as claimed in claim 1, further comprising: receiving the transmitted energy consumption information via a serial communications protocol.

3. The method as claimed in claim 1, further comprising: validating the energy consumption information by the set top box.

4. The method as claimed in claim 1, wherein the set top box is employed as a gateway between: a utility or non-utility provider web portal hosted by a server, the smart energy meter, and a plurality of appliances.

5. The method as claimed in claim 2, wherein the serial communications protocol is selected from the group consisting of: RS485 mod-bus protocol, ZigBee, and Power-line.

6. The method as claimed in claim 1, wherein optimizing the energy consumption comprises:
monitoring energy consumption of one or more appliances;
regulating energy consumption of the appliances by budgeting for the appliances;
scheduling the appliances in the lower tariff zone of energy; and
overriding curtailment initiatives using a web user interface for optimizing the energy consumption.

7. The method as claimed in claim 6, wherein the web user interface is hosted and managed by a utility or non-utility service provider.

8. The method as claimed in claim 6, wherein the web user interface provides a user weather or utility-based controlling of the appliances.

9. The method as claimed in claim 6, wherein the appliances are budgeted on daily, weekly, or monthly basis or on energy tariff basis.

10. The method as claimed in claim 1, further comprising: providing an update on energy consumption to the user displayed as a ticker message, a RSS feed, or a server-sent event using the television.

11. The method as claimed in claim 1, further comprising: enabling a user to generate daily, weekly, peek hour, customized energy consumption detailed statistics including the energy consumption price at that time based on the current tariff using an energy viewer application on the said television.

12. The method as claimed in claim 1, further enabling a user to optimize energy consumption by conjugating the analyzed energy consumption information from the remote server with dynamic tariff data of energy consumption to suggest the best possible power saving options.

13. The method as claimed in claim 4, further comprising: enabling an energy provider to predict supply and demand imbalances and accordingly plan for tuning the energy grid using detailed data collected through the home energy information gateway.

14. The method as claimed in claim 1, further comprising: enabling the user to view and manage home energy consumption by the at least one appliance using the internet via secure communication.

15. The method as claimed in claim 1, further comprising: displaying one or messages on the television received from the remote server, wherein the messages are selected from a group consisting of: news update, tariff update related to energy consumption, and appliance budget exceeding message.

16. A system for effective management of energy consumption by a plurality of appliances, comprising:
a plurality of appliances communicatively coupled with a home energy information gateway over a home area network;
an advanced energy smart meter communicatively coupled with the plurality of appliances and the home energy information gateway over the home area network adapted to identify energy consumption information about the plurality of appliances at pre-defined intervals and transmit the same;
a set top box (STB) communicatively coupled with the home area network adapted to: receive the transmitted energy consumption information by the advanced energy smart meter via a serial communications protocol, Zigbee, M Bus or power line; communicate the received energy consumption information to a remote server for billing of energy consumption at pre-scheduled intervals; and validate the energy consumption information;
an analytics rule engine running on the home energy information gateway adapted for supporting analytics of energy consumption data of the plurality of appliances;
a television adapted to display the validated energy consumption information and analysed energy consumption data of the plurality of appliances for enhancing an end-user experience; and
a utility or non-utility server hosting a utility or non-utility web portal connected through internet.

17. The system as claimed in claim 16, wherein the home energy information gateway analytics rule engine is adapted to analyze energy consumption data for each of the appliances as well as overall energy consumption data.

18. The system as claimed in claim 16, wherein the appliances are selected from the group consisting of: a refrigerator, a washing machine, an air conditioner, a television, and a microwave.

19. The system as claimed in claim 16, wherein the set top box further comprises multiple universal serial bus ports.
